(19) United States
(12) Patent Application Publication
(10) Pub. No.: US 2004/0055563 A1
(43) Pub. Date: Mar. 25, 2004

(54) Interchangeable 2-stroke or 4-stroke high torque power engine

(76) Inventor: Robert Louis Giuliani, Honolulu, HI (US)

Correspondence Address: R.L. GIULIANI, A-1204, 1456 THURSTON AVE., HONOLULU, HI, 96822, US

(21) Appl. No.: 10/643,274

(22) Filed: Aug. 18, 2003

Related U.S. Application Data
(63) Continuation-in-part of application No. 10/252,927, filed on Sep. 24, 2002.

(51) Int. Cl. F02B 75/02

(52) U.S. Cl. 123/311

(57) ABSTRACT

This is a high torque power, reciprocating engine. It is interchangeable between a 2-stroke and a 4-stroke by easily repositioning an idler gear. The combustion cylinder is sized to get the most complete combustion for high fuel efficiency and reduced exhaust emissions.

Power is transmitted between the piston and shaft through a rugged, efficient 1-way clutch, which is also described. Each piston in a pair is offset from the shaft's axis by the radius of its 1-way clutch, which causes instant peak torque at the beginning of the power stroke. The drive races of the pair of 1-way clutches engage opposite sides of the idler, whereby synchronous reverse motion is transmitted to the second piston in the pair as the inner race transmits power to the shaft. Selectively deactivated pairs of pistons are motionless in their cylinders without putting load on the shaft because of the 1-way clutch's overrun feature.

In a 2-stroke, there is power stroke overlap with two or more pairs of pistons. In a 4-stroke, there is power stroke overlap between two or more banks with two pairs in each bank. An engine computer synchronizes operation between the pairs and the banks.

### CROSS-REFERENCE TO RELATED APPLICATIONS

This is a continuation-in-part of application Ser. No. 10/252,927 file date Sep. 24, 2002 titled: Engine with 1-way clutch between a piston and power shaft.

### FEDERALLY SPONSORED RESEARCH OR DEVELOPMENT

Not applicable.

### BACKGROUND OF THE INVENTION

Engines that transmit an offset piston's power to a straight power shaft have been attempted since at least 1921, e.g. U.S. Pat. No. 1,365,666 but have not had practical success though they inherently offer high torque and high fuel efficiency. Their weakness lies in using many energy absorbing moving parts and combustion chambers to convert the piston's reciprocating rectilinear motion to the power shaft's unidirectional rotary motion which has made them inefficient and impractical, e.g. U.S. Pat. Nos. 2,239,663 and 5,673,665. For this reason, the simple, exhaust polluting, inefficient but reliable crankshaft engine survives as the search for a better power source continues.

Enormous funds and research have been poured into fuel cells, electric vehicles, rotary engines and crank engine hybrids for years in an unsuccessful effort to replace the ubiquitous crank engine.

The crank engine is very fuel inefficient because the two angles at both ends of the connecting rod of length L and the crank angle α (FIG. 14) combine to slow the piston's speed, which traps the very rapidly expanding combustion gases in a small chamber. The gases build up very high heat and pressure at and near tdc. Here, nearly all the force from the pressure is vectored against the crankshaft's bearings instead of rotating it. Parts inertia is combined with extra fuel on each power stroke to overcome the angles' resistance. The result is excess exhaust pollution and waste heat. The waste heat is lost and the pollutants are partly scrubbed from the exhaust when it is too late.

The pollution and the waste heat must be reduced in the combustion chamber by converting them to mechanical motion with a more complete burn. To do that, all the rod and crank angles must be zero during the entire power stroke but that is impossible in a crank engine. The following mathematics explains why:

FIG. 14 is a schematic that represents a crank engine. FV1, FV2, FV3 are force vectors that come from burn pressure driving the piston 38. FV1 is along a radial of the crankshaft axis C. Only FV3, being tangent to the crank circle d, rotates the shaft where FV3=FV1(Cos θ)(Cos Φ). FV1(1)(0)=0. When FV2 is tangent to circle d, Cos Φ=1.0 and Tan θ=r/L and θ=Tan⁻¹(r/L) from which Cos θ is found. The efficiency at that point is FV3/FV1=Cos θ. The importance of angle θ=Tan⁻¹(r/L) will be shown below.

The ratio of the displacement M along the crank circle d to the piston's displacement a at any chosen crank angle α is easily found from FIG. 14. r is the crank arm length and α is in degrees:

r=b+a

a=r(1−Cos α)

M=παr/180

M/a=πα/[180(1−Cos α)]

For instance, when α=10°, M/a=11.49:1. At this point, the rod's slow crank end must go 11.49 times as far as the piston. The slower the crank's rotation, the longer the gases are trapped in a small chamber and the lower the engine's efficiency. It is known that this is where the confined hot, pressurized gases create most of the pollution and waste heat. The crank's angular efficiency:

Cos θ=FV2/FV1

Cos Φ=FV3/FV2

FV2=FV1(Cos θ)

FV2=FV3/Cos Φ

FV3=FV1(Cos θ)(Cos Φ)

FV3/FV1=(Cos θ)(Cos Φ) Crank engine's angular efficiency. It caps the burn efficiency.

FIG. 14 is also the basis for the following indented equations that lead to the Cos θ and Cos 101 equations in terms of crank angle α, length L and crank arm r:

180−β=γ

γ+θ+Φ=180

β=90−α Note the rt. triangle (α+β+90)

180−(90−α)=γ or 90+α=γ

(90+α)+θ+Φ=180

α+θ+Φ=90

n=r Sin α

Sin θ=(r/L)Sin α

θ=Sin⁻¹[(r/L)Sin α]

Cos θ=Cos {Sin⁻¹[(r/L)Sin α]}

α+Sin⁻¹[(r/L)Sin α]+Φ=90

Φ=90{α+Sin⁻¹[(r/L)Sin α]}

Cos Φ=Cos(90−{α+Sin⁻¹[(r/L)Sin α]})

The equations Cos θ, Cos Φ0 are easily solved with a hand calculator. For instance, they give the angular efficiency=22.4% when α=10°; r=1.5″; L=5.0″. Since the burn efficiency is low (See M/a above) the total efficiency has to be much less than 22.4% in this example. The efficiency increases as α increases but the combustion pressure decreases as α increases. A higher rpm increases efficiency but that has reached its limit and it is not good enough.

The importance of angle θ=Tan⁻¹r/L now follows. That is when FV2 is tangent to the circle d at the arm r which makes angle Φ=0.0 and Cos Φ=1.0. The angular efficiency is Cos θ=Cos(Tan⁻¹r/L). In the example above where r=1.5″; L=5.0″; FV3/FV1=Cos θ=95.8°/. Extend L relative to r so that angle θ goes to 0.0. Then

$${Lim C}_{θ \to 0.0} o s θ = 1.0 .$$

(This is the foundation for differential calculus). That makes the angular efficiency FV3/FV1=(Cos θ)(Cos Φ)=(1)(1)=100% because there is no angular resistance since the angles θ, Φ disappear. The variable angle α disappears. The crank arm r disappears. The variable length torque arm n (FIG. 14) which requires torque buildup is replaced by the fixed length torque arm r′ (FIG. 15) which gives instant peak torque.

Unlike the crank, FV1 in this invention (FIG. 15) is always directed to rotating the output shaft 8 rather than directed against the shaft's bearings. FV1 is transmitted with both angles θ, Φ=0.0 through the entire power stroke. The M/a=1:1 through the entire stroke. The circumference d′ replaces the crank circle d in FIG. 14. Motion is transmitted through the fixed length torque arm r′ to the output shaft 8.

### BRIEF SUMMARY OF THE INVENTION

This is a high torque power, fuel-efficient engine that can be easily switched between a 2-stroke and a 4-stroke. A pair of combustion cylinders and their related pairs of parts, including 1-way clutches, are connected by an idler gear to make the basic 2-stroke engine. A third idler connects two pairs to make a 4-stroke engine. Computer controlled ignition allows power stroke overlap by equally spaced-apart applied power. The crankshaft is replaced by a straight power shaft.

A rugged 1-way clutch transmits power between the power piston and the output shaft. The piston is offset from the shaft's axis by the radius of the 1-way clutch at the point where it engages the piston connecting rod. Though conventional 1-way clutches will work, many are inefficient because they transmit motion between the races through two vectors. One vector is parallel to the clutch radial, which does not transmit motion. Instead, its energy is converted to waste heat that can contribute to early clutch failure. A preferred 1-way clutch that efficiently transmits torque between its races perpendicular to a clutch radial is described below with reference to FIGS. 7-13.

The math below can be used to calculate important values in designing a 2-stroke and a 4-stroke.

Objects of this invention include:

1. easily interchanged between 2-stroke and 4-stroke;

2. low cylinder expansion rate with a small bore, which allows more complete combustion of a small combustion charge resulting in high fuel efficiency;

3. instant peak torque at the beginning of the power stroke;

4. the 1-way clutch overrun feature allows deactivating pairs of pistons without load on the shaft;

5. reduced mass engine compared to a crank engine;

6. a rugged, breakaway 1-way clutch that is easily disassembled and reassembled for repairs;

7. lightweight piston and rod due to compression forces only;

8. piston always square in its cylinder reduces cylinder wear.

### BRIEF DESCRIPTION OF THE DRAWINGS

In the drawings: FIGS. 2,3 show a representative 1-way clutch of any suitable design but a preferred rugged design in which motion is transmitted between races perpendicular to clutch radials is described with reference to FIGS. 7-13. Number 89 refers to a cover plate in FIGS. 10,13 and to a cover plate with cartridge, including its elements in FIGS. 7,8. The outer race is referred to by its separate parts 5A, 5B and 5C in FIGS. 7,8 and as a whole by the number 5 in the other FIGs. Number 82 and number 96 in FIGS. 7,8 refer to equivalent parts. The output shaft is represented by its axis 91 in FIG. 8. Parts are shown with solid lines in drive and dashed lines in overrun.

FIG. 1 is a side view showing how movement of parts is synchronized between a pair of pistons.

FIG. 2 is taken essentially along line 2-2 in FIG. 1 to show how motion is transmitted between a piston and a 1-way clutch through a gear mesh.

FIG. 3 shows how a belt or a chain replaces the gear mesh in FIG. 2.

FIG. 4 shows a means for decelerating and reversing pistons at the end of the stroke.

FIG. 5 shows two computer controlled pairs of cylinders combined with an energy storage device.

FIG. 6 shows a 4-stroke engine by combining two pairs with a third idler 40A.

FIG. 6A focuses on separation of idler 40A from the sector gears in FIG. 6 to create a 2-Stroke.

FIG. 7 shows an oblique view of the 1-way clutch with keystone shaped interlocking teeth on the outer race.

FIG. 8 is an exploded view of the several parts of the FIG. 7 clutch aligned along a shaft axis. Alternatively, pegs with matching holes replace the teeth in FIG. 7.

FIG. 9 is a side view of a replaceable clutch cartridge with its cover plate removed and casing broken away to show the internal elements of a hydraulic torque transmitting member.

FIG. 10 is a cross sectional along 10-10 in FIG. 9.

FIG. 11 is one embodiment of a mechanical torque transmitting member.

FIG. 12 is a second mechanical embodiment of a torque transmitting member.

FIG. 13 shows a cross sectional along 13-13 in FIG. 11.

FIG. 14 is a schematic of a crank engine used for mathematical reference in the text above.

FIG. 15 is a schematic of this invention used to mathematically compare with FIG. 14.

### DETAILED DESCRIPTION OF THE INVENTION

### Underlying Mathematics

The discussion below references the following equations by their definitions, e.g. F lbf. Some complete equations are also included in the discussion.

Definitions:

1 BTU=778 ft-lbf

1 hp=550 ft-lbf/sec

2πr′=length of 1-way clutch rim at connecting rod contact. (ft)

F—actual combustion force (lbf)

F′—fuel's ideal combustion pressure (psi)

Fr—fuel flow rate (lbm/sec.)

hp—shaft horsepower

Lo—Power losses (fraction of hp)

n—total number of pistons. 2,4,6, . . .

n/2—2 stroke. Number of equally spaced overlapping pistons cycling through the power stroke.

n²/2—2-stroke shaft power. (ft-lbf/sec).

n/4—4-stroke. Number of equally spaced overlapping pistons cycling through the power stroke.

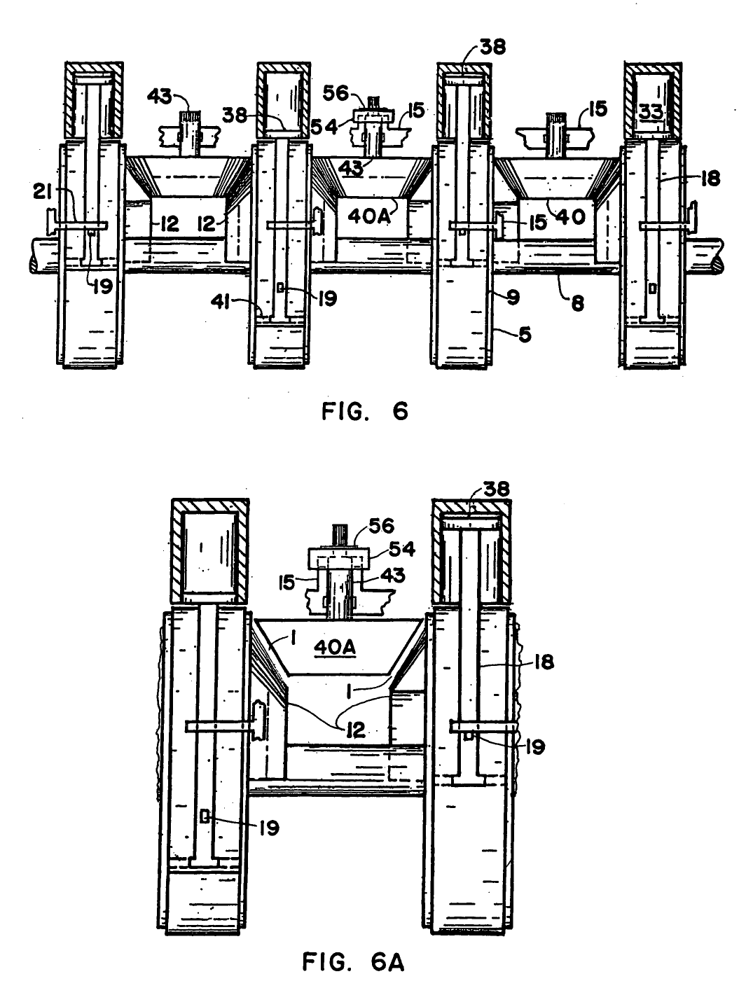

n²/4—4-stroke shaft power. (ft-lbf/sec) See FIG. 6.

Qc—fuel's energy density. (BTU/lbm).

r′—1-way clutch radius at connecting rod contact. (ft). See FIG. 15.

r_{b}—radius of cylinder. (in)

Rv—power shaft's rotation rate. (rpm)

Sp—shaft power+losses. (ft-lbf/sec.)

T—shaft torque. (lbf-ft)

Vp—piston's velocity. (ft/sec)

Equations:

Vp=π(r′)(Rv)/(30) Piston rod's speed and the 1-way clutch rim speed are equal at contact.

r′=60(Vp)/2π(Rv)=30(Vp)/π(Rv) r′ is central to this engine's design and operation.

Rv=30(Vp)/πr′

Sp=550 hp(1+Lo)

Fr=(Sp)/(778Qc)

Fr=(F)(n²)(Vp)/[2(778)(Qc)] For a 2-Stroke

F=2Sp/(n²Vp) For a 2-Stroke

T=F(r′)

F′=F/[π(r_{b}²)]

r_{b}²=F/(πF′)

bore=2\sqrt{F/(πF′)}

The advantage of overlap is evident in the next two examples that compare the number of cylinders in this smaller engine with the number of cylinders in a crank engine of equal power. The examples also show the power advantage of this engine's overlapping 2-stroke over its 4-stroke.

1. Example of this 2-stroke engine with n cyls. vs. the number of crank engine cyls. of equal power:

Let n=6 then n²/2=18 crank engine cyls.

2. Example of this 4-stroke engine with n cyls. vs. the number of crank engine cyls of equal power:

Let n=8 (two banks of 4 pistons each in FIG. 6) then n²/4=16 crank engine cyls.

The deactivation feature also makes a 4-Stroke bank combined with 2-Stroke pairs advantageous.

Discussion.

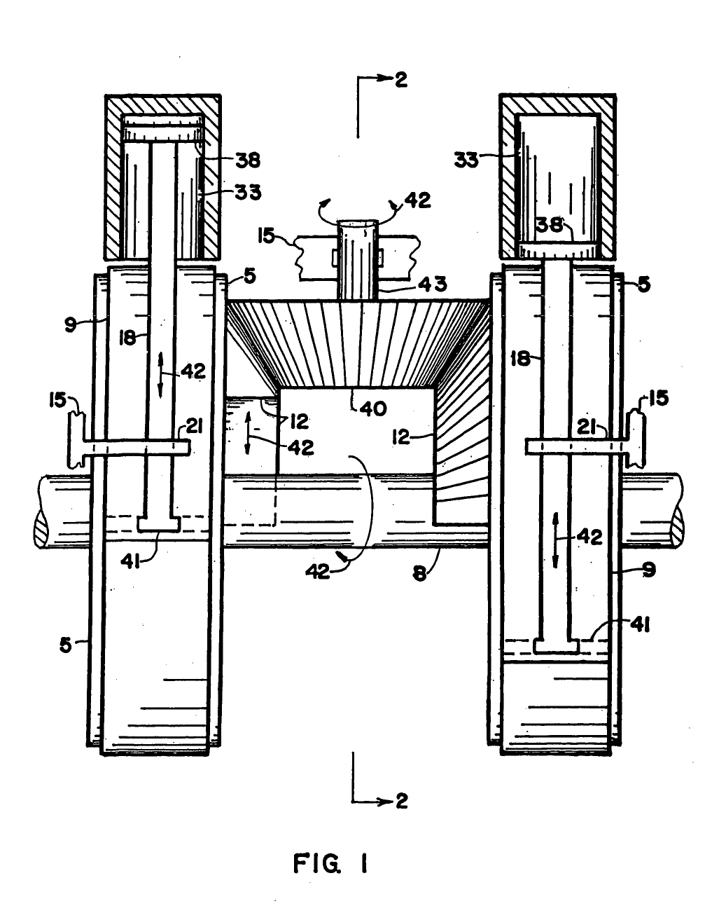

A pair of combustion cylinders 33 and related pairs of parts that include a pair of 1-way clutches (FIGS. 1-3) make the basic 2-stroke engine in this invention. The clutch's inner race 4 is keyed to the power shaft 8. The outer race 5 carries a sector gear 12. Each gear 12 engages an opposite side of idler 40 whereby synchronous reverse motion is transmitted between the power piston 38 to the second piston 38 in the pair as the inner race 4 transmits the power to the shaft 8. Moving parts that are not shown with arrows 42 are presumed obvious.

Combining two pairs with idler 40A creates a 4-stroke shown in FIG. 6 that will be described later under Interchanging 4-Stroke and 2-Stroke.

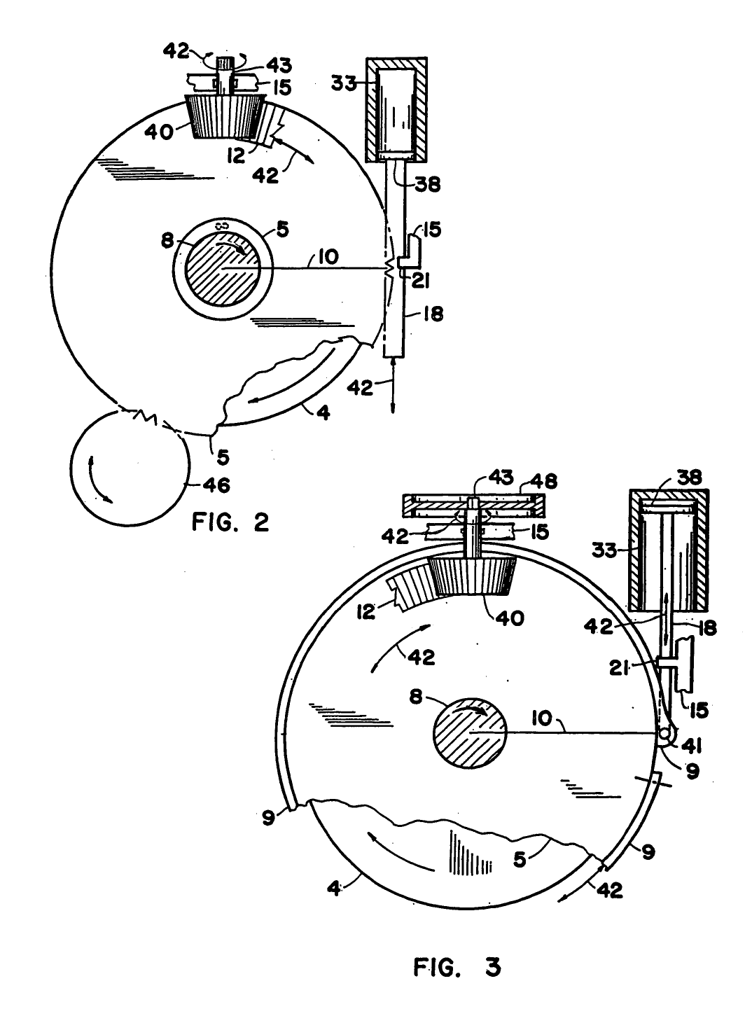

FIG. 2 shows a gear mesh to transmit the piston's power between piston rod 18 and the outer race 5 of the 1-way clutch. Rod 18 reciprocates along a straight path 42. FIG. 2 also shows a reciprocating starter 46 gear meshed with the outer race 5. By shifting race 5, the starter shifts both pistons 38 until ignition. Alternatively, shaft 43 can be used to shift the pistons until ignition. The 4-stroke version in FIG. 6 needs one starter (not shown).

One end of a V-belt or a chain 9 is fastened to the outer race 5 (FIGS. 1,3). The way it is wrapped around race 5 always keeps it taut, which prevents backlash as it rotates race 5 in response to the power stroke. Rod 18 is connected to the other end of the belt or chain 9 with a suitable fastener 41.

The 1-way clutch's override feature in this engine allows power shaft 8 and the clutch's inner race 4 to rotate independently of the pistons 38 when the inner race's speed is greater than the outer race 5 speed. This feature creates regenerated energy for collection in an energy storage device 26 (FIG. 5) available, e.g. for dumping to shaft 8 on demand or generating electricity.

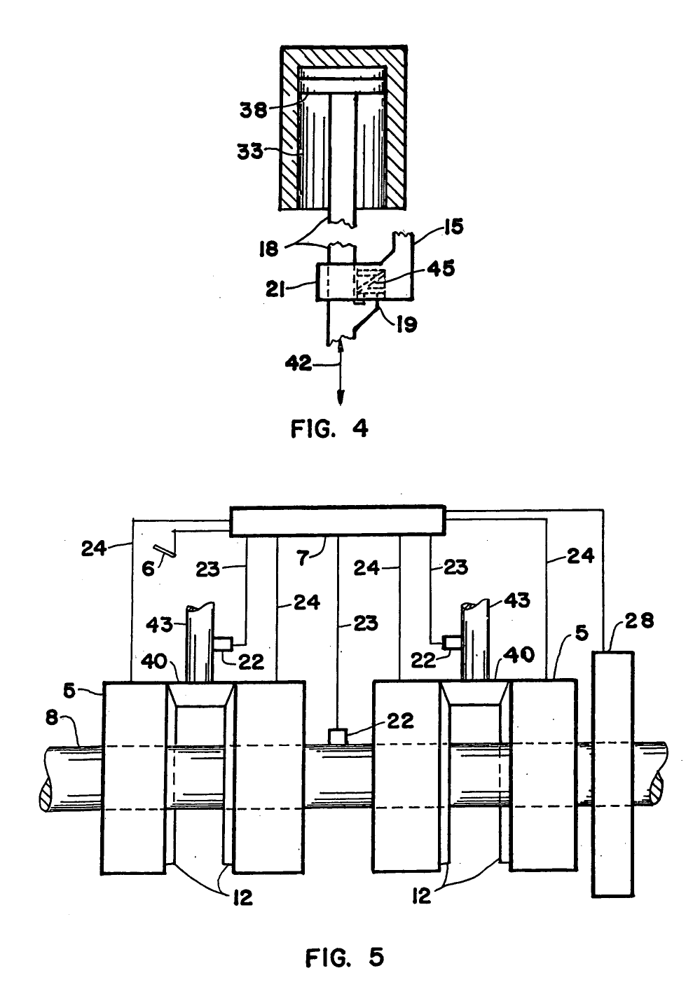

The fixed length torque arm 10 (FIGS. 2,3) causes instant peak torque at the beginning of the power stroke. A connecting rod guide 21, secured to housing 15, eliminates side thrust and reduces wear by keeping the piston 38 square in its cylinder. Wrist pins and piston skirts are not needed. The guide 21 combines with a decelerator mechanism (FIG. 4) to stop piston 38 at or near top dead center. The decelerator includes a node 19 that is part of each rod 18 in a pair and a spring 45 for each node. The spring is encased in the guide 21. An opening in the housing 15 allows easy replacement of the spring. The spring absorbs the impact of node 19 to halt the motion of piston 38, which is then accelerated on its power stroke by timely expanding combustion gases. The impact is reduced because node 19 is decelerating due to the power loss of the power piston to the shaft 8. The decelerator is positioned to prevent backlash of the gears 12 (FIGS. 1,6) that mesh with idler 40.

A computer 7 (FIG. 5) monitors input from the throttle 6 and shaft power from the sensor 22 on shaft 8 through leads 23 to determine the size of the combustion charge (Fr=(Sp)/(778Qc) lbm/sec) to transmit to the cylinders through injector lines 24. The position of piston 38 is monitored through sensors 22 on shaft 43 and used for ignition timing. By monitoring the motion of each shaft 43 in several pairs, the computer controls timing between the unconnected pairs in a 2-stroke embodiment. The computer begins a power stroke with a piston in one pair when a piston in another pair is partly through its power stroke. In a 2-stroke, 50% power stroke overlap and smooth rotation of the shaft 8 is had with two unconnected pairs (four cylinders). Greater overlap is gained with more pairs.

Small Flywheels.

Load changes on shaft 8 could decrease F lbf below what is needed for an efficient combustion pressure. A small, suitable flywheel 48 is splined to the end of shaft 43 (FIG. 3) to briefly increase chamber pressure for a more complete combustion with decreased emissions. Then it dispenses the regenerated energy that it gains to moderate the speed of the pistons 38. A conventional flywheel can be used but an alternative comprises three concentric parts. The inner part is splined to shaft 43. The outer part extends to the flywheel's rim. Between them is a tough, slightly elastic part that absorbs some of the initial ignition jolt.

Interchanging 4-Stroke and 2-Stroke.

There are at least two simple ways to effect this change. In a 4-stroke, a sector gear 12 on two pairs engages idler 40A (FIG. 6). A cap 54 having a hole is removably secured, e.g. threaded, to the engine 15. The shaft 43 of idler 40A has two diameters. The shorter one extends through the hole. A snap ring 56 on the shorter diameter abuts the cap and combines with the larger diameter that abuts the inside of the cap to prevent the idler 40A from axial movement which keeps the idler properly engaged with the two sector gears. When changing to a 4-stroke from a 2-stroke, the pistons must be correctly aligned before engaging the idler with the sector gears. One of the correct alignments is shown in FIG. 6 with 2 pistons at top dead center and 2 at bottom dead center. Power stroke overlap for a 4-stroke can be achieved by adding another bank of two pairs along the shaft 8 disengaged from the bank shown in FIG. 6 or by adding separate pairs. To avoid cluttering, FIGS. 6,6A show the splined end of shafts 43 without flywheels 48.

The separation 1 in FIG. 6A makes the 4-stroke a 2-stroke. To change to a 2-stroke from a 4-stroke, the cap 54 is partly unscrewed to a predetermined position on the engine 15, which raises shaft 43 and disengages idler 40A from sector gears 12 (FIG. 6A). The cap is held in place by known means, e.g. a dowel through the side of the cap that contacts engine 15.

Alternatively, for a 4-stroke, one or more dowels through engine 15 engage a circular groove in shaft 43 to prevent axial movement but allows rotary motion of idler 40A while engaging sector gears 12. To change to a 2-stroke, the dowels are removed from the groove. Shaft 43 is lifted to where the dowels are inserted in a second groove, which separates idler 40A from sector gears 12.

Hydrogen Enhanced Ignition of the Primary Fuel.

In some applications, considerable regenerated energy from shaft 8 is anticipated from the 1-way clutch's overrun feature. The device 26 (FIG. 5) includes a means (not shown) to convert the energy to hydrogen (H₂) and a temporary H₂ storage tank. A minimal of the H₂ is injected into the combustion chamber with the primary fuel.

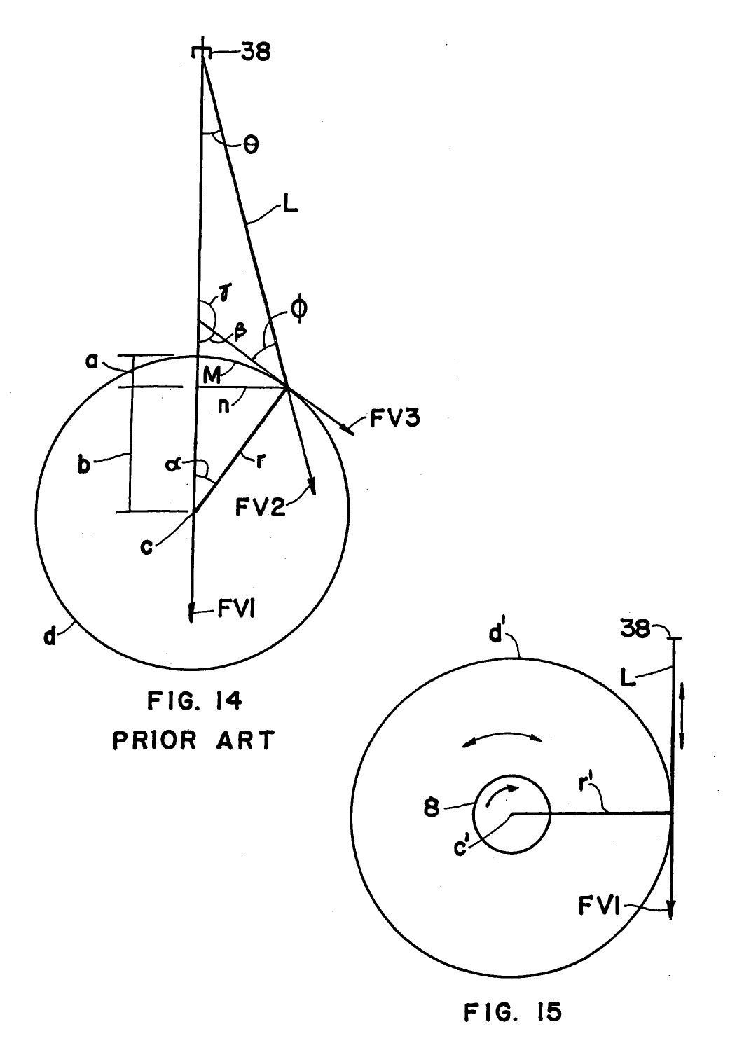

Hydrogen's “flame speed” in an H₂ rich mixture is about 6 times faster than gasoline. (Energy Technology HDBK, pp. 4-39 to 4-43, Considine, 1977). H₂ has a high energy density in the high pressure combustion chamber. High heat from the ignited H₂ saturates the primary fuel to cause a more complete burn of the primary fuel's droplets, which increases fuel efficiency. The high, prolonged pressures that cause NOx will be greatly reduced if Vp and r′ are selected to allow a fast piston acceleration to reduce the pressure. If needed, flywheel 48 fine adjusts the acceleration and pressure for the best burn. M/a=1:1 (See M/a above) and the angles θ, Φ, α (FIG. 14) do not exist.

Parabolic Reflector Cylinder Head.

A drawing is believed unnecessary to describe this embodiment. The entire cylinder head is a parabolic reflector with an igniter at its focus. The focus is at the end of a replaceable plug. An energy wave expands from the igniter to hit the parabolic reflector and the reflector directs the energy wave to uniformly impact the flat piston crown at or near top dead center. Both pistons in a pair will be decelerating due to power bleed and the additional wave energy will help to reverse and accelerate both pistons 38 from zero where it is most effective in saving fuel.

1-Way Clutch with Axial Extension.

This embodiment is also not shown with a drawing. In FIGS. 1-3, the rod 18 engages the outer race 5 at its rim. If the rim radius cannot be reduced enough to obtain sufficient combustion pressure, an extension of race 5 along shaft 8 has a shorter radius. The rod 18 engages the extension's rim at the shorter radius rather than the race 5 rim. Rod 18 reciprocates along its straight path, tangent to the extension's rim. Motion from combustion pressure is transmitted to the race 5 extension. Race 5 transmits the motion to the inner race 4 at the longer radius.

Preferred 1-Way Clutch Embodiment

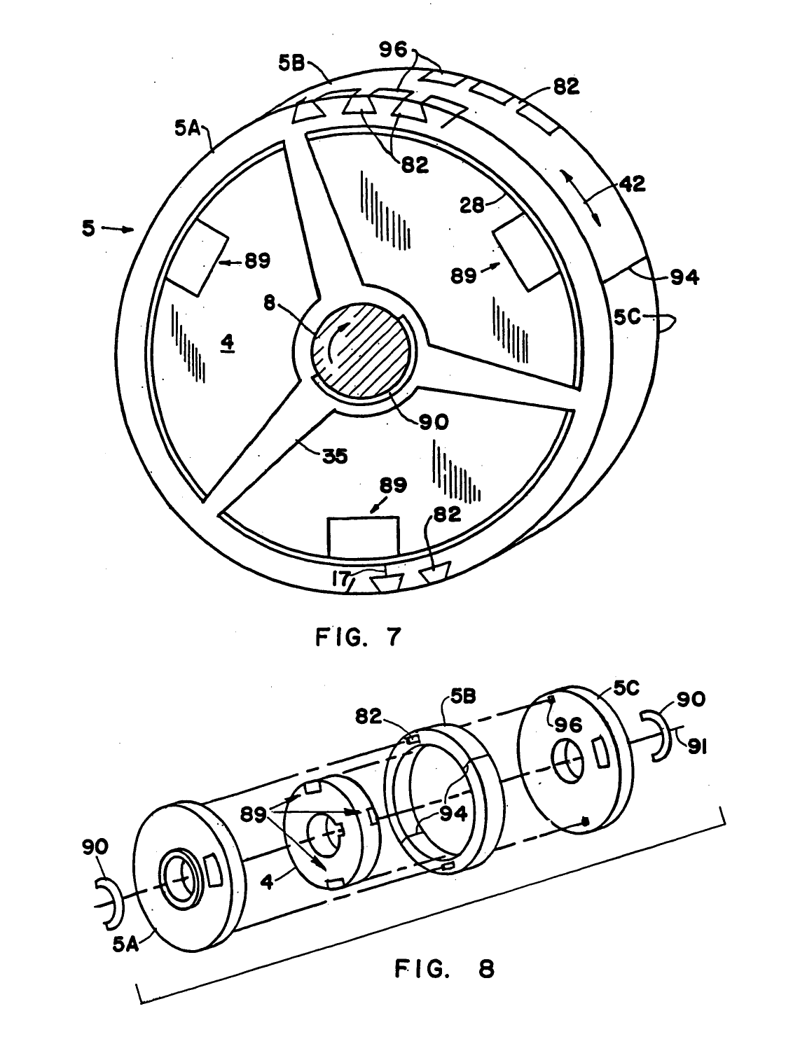

The preferred breakaway 1-way clutch is shown in FIGS. 7-13. Its outer race 5 drives clockwise in its indexing motion 42. The outer race 5 has three separate parts: sides 5A, 5C and race 5B. Race 5B is the outer rim of the gap 28 (FIGS. 7,9-11,13). The gap is narrow and near the race 5B to reduce stress on the parts. FIG. 7 shows the torque transmitting units 89 in relation to the gap.

Keystone shaped teeth 82 (FIG. 7) extend from race 5B and make a strong interlocking fit with keystone shaped teeth 96 on the sides 5A and 5C. The fit locks the parts together radially and circumferentially but allows them to be easily moved axially for disassembly by removing the snap rings 90 (FIG. 8). FIG. 8 shows equivalent pegs 82 that fit into holes 96 in sides 5A and 5C. There are as many teeth or equivalent pegs as needed.

The inner race 4 is keyed to power shaft 8. A snap ring 90 carried by shaft 8 on each side of the race 5 (FIG. 8) keeps the clutch from shifting along the axis 91 of shaft 8. The snap rings also prevent separation of the three outer race parts. In extreme or unusual use, a dowel 17 (FIG. 7) reinforces the snap rings to keep the parts together. It extends through race 5A and 5C to contact a keystone shaped tooth 82 (or an equivalent peg 82 in FIG. 8) on each side of race 5B. It is easily displaced for breakaway to replace race 5B.

FIGS. 7,8 show two halves of race 5B that are kept in contact 94 by the teeth (or pegs). When race 5B is separated from sides 5A and 5C, the halves fall apart for replacement without separating the other parts from shaft 8.

Bearings in FIG. 7 are between the outer race 5 and the shaft 8. Spokes 35 in side 5A and side 5C reduce material cost and reduce indexing inertia The transmitting units 89 are easily replaceable when positioned between the spokes or behind an aperture in the sides 5A and 5C.

Move the bearings to the conventional position at gap 28 and the dowel (FIG. 7) can keep the parts together without the spokes 35.

The cover plate 89 (FIGS. 10,13) is designed to guide the moving parts during their movements.

Hydraulic Embodiment of the 1-Way Clutch.

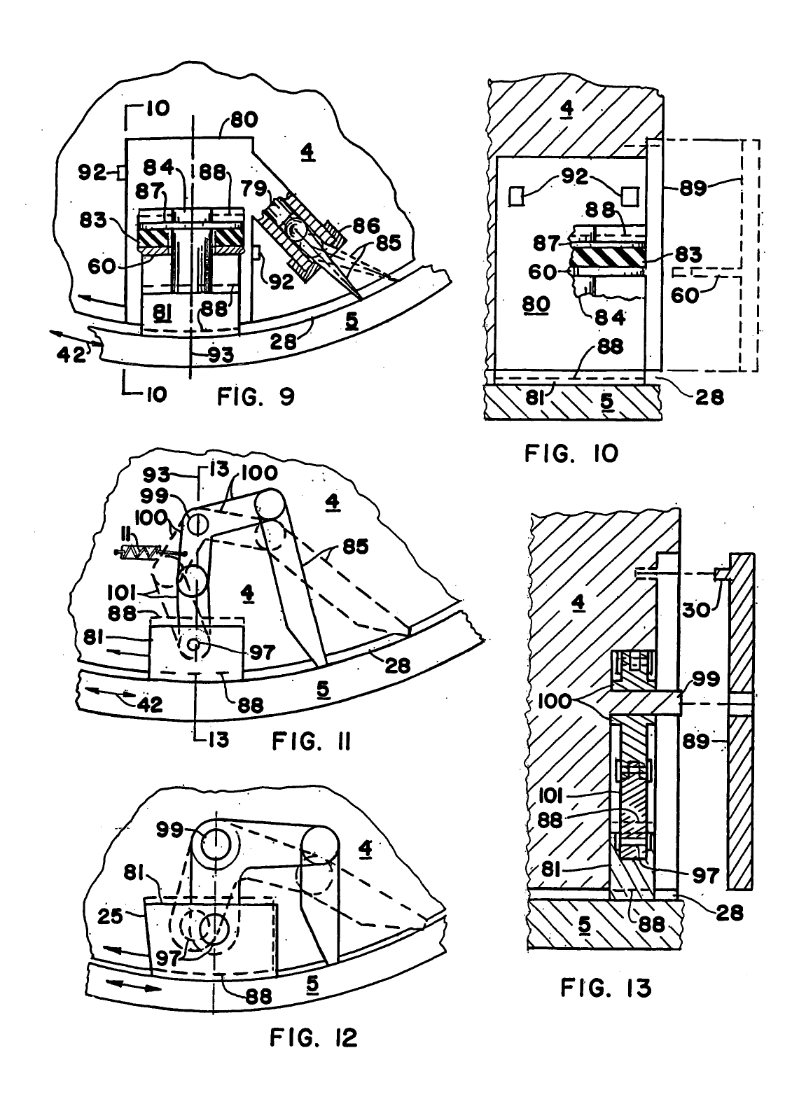

Replaceable hydraulic cartridges 89 (FIGS. 7,8) are carried by race 4. The race is molded to rigidly hold the cartridge casing 80. Pegs 92 (FIG. 9) slide into grooves in the race 4 to reinforce the cartridge against movement, especially toward race 5 under centrifugal force. A unit piston 81, shown in driving contact with race 5 (FIGS. 9,10), moves a short distance 88 along the clutch radial 93 (FIG. 9) while in sliding contact with the casing 80 and the casing is in contact with race 4. The piston is secured to a piston rod 84 (FIGS. 9,10) that is hydraulically actuated from a reservoir section of the casing from which it extends. Torque between race 5 and race 4 is transmitted through the piston perpendicular to radial 93 that extends from the axis 91 (FIG. 8) of shaft 8. The casing 80 has an arm that holds a plunger 79 in contact with the ball end of a trigger 85. A cap 86 having a slot aligned with the trigger's motion is immovably secured to the arm. The trigger extends through the slot to contact the race 5. A resilient piece inside the cap between it and the ball end is preferred. The angle between the arm and the radial is small to prevent jamming between the arm and the trigger.

As the trigger 85 shifts from its overrun position to the drive position, it pushes the plunger 79 farther into its arm to displace hydraulic fluid in the reservoir contained in the casing 80. The fluid displaces the piston rod 84 to drive the piston 81 into non-slip contact with race 5. The piston is in contact with race 4 and drive is transmitted from race 5 through the piston to race 4 perpendicular to a clutch radial. One contact surface of the piston or race 5 should have a V-groove and the other shaped to increase non-slip friction upon contact. The trigger's motion is unhindered as it moves the piston from the overrun position 88 to contact the race 5, except for compressing a resilient element 83 (FIGS. 9,10).

The two-part resilient element 83 fits around the rod 84 for easy replacement. The element is positioned between a plate 87 that is part of the rod and a two-part, immovable second plate 60 that is part of the casing 80 and cover plate 89. When the trigger shifts to its drive position, the element is compressed between the two plates as the hydraulic fluid drives the rod 84 to bring the piston and race 5 into non-slip contact. The element expands against the immovable plate 60 to shift the piston to its overrun position 88 when the trigger shifts to its overrun position and releases the fluid pressure.

Mechanical Embodiments of the 1-Way Clutch.

Two of at least three mechanical versions of the transmitting units are shown in FIGS. 11,12. A casing for them is omitted to show a cost saving but can be included. The cover plate 89 and race 4 substitute for the casing 80. Without a casing, the piston 81 is always in direct, sliding contact with race 4 as it reciprocates along the radial 93 that extends from the clutch axis 91 (FIG. 8). Like the hydraulic version, the short reciprocal motion goes between contact with the race 5 and position 88. Drive is transmitted perpendicular to the radial 93 from race 5 through the piston to race 4.

FIG. 11 shows the piston 81 connected to a piston rod 101 by a wrist pin 97. The rod is connected to a lever 100 which, in turn, is connected to the trigger 85. All the connections are hinged to allow pivoting. The lever's fulcrum 99 extends from race 4. A cantilevered fulcrum (not shown) uses a snap ring or common washer and cotter pin to retain the lever. But a stronger fulcrum fits into a hole in the plate 89 (FIG. 13) which is preferred for heavy duty. Three pegs 30, placed at the apexes of a broad triangle on plate 89, rigidly fix the plate to the race 4 in all embodiments. The angle between the lever 100 and the trigger 85 equals or is very close to 90° in the drive position to reduce stress on the trigger and its connection with the lever. The angle between the rod 101 and lever is preferably not straight when the piston contacts race 5. After contact, the angle straightens to increase pressure between the piston, the race 5 and lever's fulcrum 99 with limited force upon the trigger. A spring 11 insures instant separation of the piston 81 from race 5 as overrun begins.

The second mechanical version is shown in FIG. 12. Some reference numbers for the same parts in FIG. 11 are omitted in FIG. 12 to avoid overcrowding. In FIG. 12, the rod 101 is discarded by connecting one arm of the lever 100 directly to the wrist pin 97. A slant 25 of the contact surfaces is provided between the piston 81 and race 4. The spring 11 in FIG. 13 can be included.

Not shown is a third mechanical version that sets the piston on one radial of the clutch and the fulcrum on another. It can also eliminate the rod 101.

In all the 1-way clutch embodiments: (1) the angle at the trigger's two extreme positions must not cause jamming, (2).the trigger should be coated with a suitable ceramic and shaped to reduce drag but instantly grab the outer race when reversing to the drive direction, (3) the piston's motion 88 goes only far enough to provide clearance between the piston and the outer race during overrun and (4) one of the contact surfaces should have a V-groove and the other contact surface beveled to fit it to prevent slip.

I claim:

1. An engine comprising:
a pair of work members each including a 1-way clutch comprising a drive race and a driven race, a combustion cylinder, a piston for reciprocating in said cylinder, a piston rod connected to the piston and transmitting power to a periphery of the drive race by a first means;
each driven race secured on a power output shaft;
an idler gear located between and driven by the drive races so that the drive races maintain synchronous motion between the two out of phase pistons as the driven race transmits the power to the shaft.

2. The engine of claim 1 wherein said first means comprises a rack gear on the end of said rod, said drive race periphery having a pinion gear engaging said rack gear, and a guide maintaining alignment between the rack and gear.

3. The engine of claim 1 wherein said first means comprises a belt or chain secured to said rod and said periphery and a guide maintaining alignment between the rod and periphery.

4. The engine of claim 1 further comprising a spring contacting a node on said rods when the pistons near top dead center.

5. The engine of claim 1 further comprising:
a cylinder head shaped like a parabolic reflector, an igniter at the focus of the reflector, the piston having a flat crown facing the reflector.

6. The engine of claim 1 further comprising means for delivering a first primary fuel and minimal amount of a secondary fuel, the secondary fuel being hydrogen and having a flame speed greater than the first fuel.

7. The engine of claim 1 comprising a flywheel wherein the flywheel moderates combustion pressures in the combustion cylinder.

8. The engine of claim 1 which includes more than one independent pairs of the work members and more than one of the pistons cycle through a power stroke overlap spaced apart.

9. The engine of claim 1 comprising a plurality of pairs of work members and means for selectively activating and deactivating the pairs.

10. The engine of claim 1 being interchangeable between a 2-stroke and a 4-stroke which includes;
more than one independent 2-stroke pair disposed along the shaft in which an idler engaging two independent pairs effects a 4-stroke engine, a disengagement of the idler reverts back to a 2-stroke engine and reengagement reverts again to a 4-stroke.

11. A 1-way clutch comprising;
a first race and a second race;
a torque transmitting unit; and
the unit carried by the first race wherein the unit transmits the torque between the races perpendicular to a radial of the 1-way clutch.

12. The 1-way clutch of claim 11 comprising;
a first contact surface on the first race and a second contact surface on the second race;
the first contact surface having a V-groove and the second contact surface beveled to fit the V-groove wherein non-slip contact is effected.

13. The combination of claim 11 which includes;
a hydraulic element;
a unit piston;
a pivotal trigger;
a resilient member; and
the trigger effecting communication between the second race and the hydraulic element wherein a first direction change in the second race actuates the hydraulic element to move the unit piston into contact with the second race which compresses the resilient member so that torque is transmitted between the second race and the first race and a change to a second direction actuates the resilient member to move the piston out of the contact so that the torque transmission is prevented.

14. The combination of claim 11 in which the unit is replaceable in whole.

15. The combination of claim 11 in which the unit comprises;
a lever;
the lever including a spring load;
a pivotal trigger;
a unit piston;
the lever communicating with the unit piston; and
the trigger communicating with the second race and the lever wherein a first direction change causes the trigger to actuate the lever to move the unit piston into contact with the second race so that the torque is transmitted between the second race and the first race and a change to a second direction actuates the spring load to reverse the lever that disengages the unit piston from the second race to prevent the transmission.

16. The combination of claim 15 in which a unit piston rod connects the lever and the unit piston.

17. The combination of claim 11 in which the second race includes;
a breakaway embodiment further comprising;
a first rim, the first rim including keystone shaped extensions along its outer edge;
a second rim, the second rim including keystone shaped extensions along its outer edge;
a peripheral band, the band comprising interlocking sections; and
the sections including keystone shaped parts along both edges wherein the parts interlock with the extensions to prevent radial separation of the embodiment while allowing axial separation.

18. The combination of claim 17 in which the embodiment includes an equivalent dowel wherein the dowel prevents the radial separation of the embodiment.

19. The combination of claim 17 which includes:
a shaft;
the shaft supporting a first journal box and a second journal box;
at least one first spoke linking the first rim to the first journal box;
at least one second spoke linking the second rim to the second journal box; and
a first snap ring adjacent the first journal box and a second snap ring adjacent the second journal box wherein axial separation of the embodiment is prevented.

20. The combination of claim 11 in which the 1-way clutch includes;
a shaft;
the second race comprising an extension along the axis of the shaft;
the extension comprising a rim;
a first radius from the axis of the shaft to the rim of the extension;
a second radius from the axis of the shaft to the rim of the second race;
the first radius being shorter than the second radius; and
a force wherein the force to the first radius is greater than the force to the second radius.
